(19) United States
(12) Patent Application Publication
(10) Pub. No.: US 2026/0251765 A1
(43) Pub. Date: Aug. 27, 2026

(54) Distance sensor and method for operating a distance sensor

(71) Applicant: SICK AG, Waldkirch (DE)

(72) Inventors: Georg SCHNEIDER, Hamburg (DE); Falko DIEBEL, Hamburg (DE)

(21) Appl. No.: 19/426,769

(22) Filed: Dec. 19, 2025

(30) Foreign Application Priority Data
Feb. 26, 2025 (EP) 25160173.8

(51) Int. Cl. G01S 7/481; G01S 13/08; G02B 27/00

(52) U.S. Cl. CPC G01S 7/4816; G01S 7/4814; G01S 7/4817; G01S 13/08; G02B 27/0018

(57) ABSTRACT

The present invention relates to a distance sensor for detecting objects in a monitored zone. According to the invention, a light-sensitive surface of a light receiver and reception optics are arranged offset relative to one another transversely to an optical axis of the reception optics such that the optical axis of the reception optics does not intersect the light-sensitive surface so that one or more ghost images of a reception light spot, which are produced by unwanted reflections of reception light signals at boundary surfaces of the reception optics, are not incident on the light-sensitive surface at least within a predefined working distance range. The invention further relates to a corresponding method for adjusting or operating a distance sensor.

The present invention relates to a distance sensor for detecting objects in a monitored zone, said distance sensor comprising a transmission arrangement for transmitting transmission light signals along a transmission light path into the monitored zone; a reception arrangement comprising a reception optics, which has an optical axis and which is configured to focus reception light signals, which are produced by an object present in the monitored zone by a remission of incident transmission light signals and which propagate along a reception light path between the object and the reception arrangement, into a reception light spot, and a light receiver that has a light-sensitive surface and that is configured to detect the reception light spot; and an evaluation unit that is connected to the light receiver and that is configured to determine a distance of the detected object from the distance sensor in dependence on the time of flight of the transmitted and received light signals.

Such a distance-measuring optoelectronic sensor, in which a time-of-flight-based distance measurement is combined with a scanning of the monitored zone, is also referred to as a LIDAR SENSOR (LIDAR: abbreviation for “Light Detection And Ranging”). The light signals can be transmitted in the form of a transmission light beam as light pulses or also as continuous light signals. If the transmission light signals or the transmission light beam is incident on an object, at least a portion of the incident transmission light is remitted in the direction of the reception arrangement, wherein the remission takes place in a specularly reflecting or diffusely scattered manner in dependence on the surface properties of the detected object. The remitted transmission light signals are detected as reception light signals by the light-sensitive surface of the light receiver and are converted into corresponding electrical reception signals. The electrical reception signals can be further processed in the evaluation unit and an object detection signal can be output, if necessary. The object detection signal can include information about the distance of the object from the distance sensor and/or its generation can depend on the distance, for example, when a distance threshold value is exceeded or fallen below.

The transmission arrangement comprises a light source, wherein LEDs, lasers, laser diodes or VCSELs (abbreviation for “Vertical Cavity Surface Emitting Laser”, a design of a surface emitter), among other things, can be used as the light source. The transmission light arrangement can produce the transmission light signals such that, in a monitored zone, a transmission light spot is projected onto an object possibly present there, wherein the transmission light spot can have different shapes. Depending on the design of the transmission arrangement, the transmission light spot can e.g. be circular, elliptical or linear. A transmission light spot, which is composed of a plurality of partial light spots e.g. arranged in a row, is also possible. Furthermore, a longitudinally extended transmission light spot can in particular also be produced by scanning a point-shaped or circular light spot or by sequentially activating a plurality of individual light sources that are arranged in a row or in a different geometry.

Photodiodes, avalanche photodiodes, photodiode arrays, SPAD arrays (SPAD: abbreviation for “Single Photon Avalanche Diode”), CMOS arrays or the like can be used as light receivers, for example.

By means of the reception optics, the reception light signals can be focused or bundled so that, on the light receiver, a reception light spot is produced that is usually an image of the transmission light spot produced on a present object. The wavelength of the transmission light can be in the visible or non-visible range, for example in the infrared range.

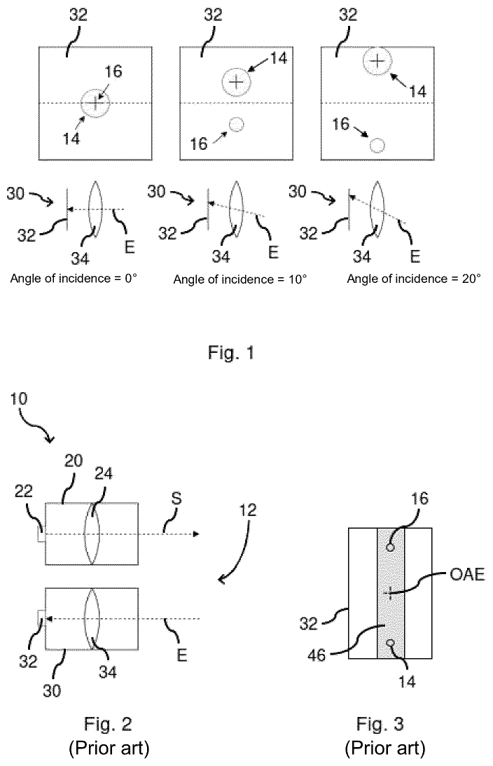

The reception optics of the reception arrangement can comprise one or more optical lenses. Since the transmission is always below the ideal value of 100% in the case of real optical lenses, reflections can occur at the boundary surfaces of the lenses. These lens reflections, which are also referred to as back reflections, scattered light or “lens flare”, can lead to ghost images of the reception light spot on the light receiver. If the angle of incidence is 0°, i.e. the main beam of the reception light beam coincides with the optical axis of the reception optics, the actual reception light spot and its ghost image are usually projected onto the light receiver at the same location. However, if the reception light is obliquely incident on the reception optics, the reception light spot and its ghost image are incident on the light receiver at different locations. This relationship will be explained in detail further below with reference to FIG. 1.

Depending on the respective application, in particular if there are large differences between the distances to be detected or if the surface properties of the objects to be detected vary, the reception light signals can have a very large dynamic range. For objects at short distances or with a highly reflective surface, e.g. a reflective surface or a surface provided with retroreflectors, the reception light signals can have a very high signal intensity so that ghost images also have a comparatively high signal strength that can distort the results of the distance measurements or can even make them impossible.

In many designs of distance sensors according to the category, the detection of the reception light signals takes place in a spatially resolved manner, i.e. the light receiver has a plurality of light-sensitive elements that are arranged in the form of a row, a column or a two-dimensional array. In particular with this spatially resolved detection of the reception light signals, any ghost images of the reception light spot have a particularly unfavorable effect and lead to an incorrect object detection.

In principle, the effect of the lens reflections can be reduced by applying reflection-reducing coatings to the lens surfaces. However, the costs for such anti-reflective coatings increase sharply with an increasing effectiveness, wherein, even with very highly effective anti-reflective coatings, a complete elimination of ghost images can virtually not be achieved.

In the case of multi-channel light receivers, i.e. light receivers comprising a plurality of light-sensitive elements, a recognition and elimination of the ghost images can take place by sequentially reading out the reception elements. However, due to the sequential reading out, the time required for the reading out is disadvantageously extended so that the detection rate is reduced accordingly.

An optoelectronic sensor is described in EP 2 708 914A1 , in which a transmission light beam is deflected in two spatial directions by means of an MEMS mirror in order to scan a scene. Depending on the deflection position, only the light reception elements within an expected position of the reception light spot are activated.

An approach for reducing light reflections in LIDAR sensors that is based on a quantification of the back reflection effects is described in U.S. Pat. No. 11,982,765B2 .

In the LIDAR system disclosed in US 2022/0120869A1 , a suppression of ghost images takes place with the aid of a plurality of reflective surfaces and apertures that are arranged between the reception optics and the light receiver.

In the LIDAR system described in US 2022/0221566A1 , the filtering out of back reflections is based on the utilization of deviating spectral properties of the ghost signals. In this LIDAR system, signals are used in which the transmission light signals are modulated with a time-varying frequency (so-called chirp signals).

It is the object of the invention to specify a distance sensor that is insensitive with respect to a detection of ghost images of the reception light spot.

The object is satisfied by a distance sensor having the features of claim 1. According to the invention, provision is made that the light-sensitive surface and the reception optics are arranged offset relative to one another transversely to the optical axis of the reception optics (in particular in a direction perpendicular to the optical axis of the reception optics) such that the optical axis of the reception optics does not intersect the light-sensitive surface so that one or more ghost images of the reception light spot, which are produced by unwanted reflections of the reception light signals at boundary surfaces of the reception optics, are not incident on the light-sensitive surface at least within a predefined working distance range.

The optical axis of the reception optics thus intersects a plane of extent of the light-sensitive surface outside the light-sensitive surface.

The transmission arrangement and the reception arrangement can, for example, be configured in a biaxial arrangement, i.e. the transmission arrangement and the reception arrangement are arranged spaced apart from one another transversely to the reception light path. Alternatively, the transmission arrangement and the reception arrangement can be configured in a coaxial arrangement, i.e. the transmission light path and the reception light path coincide in sections.

In the distance sensor according to the invention, which can in particular be configured as a LIDAR sensor, the measurement of the distance takes place in dependence on the time of flight. This is also called a TOF measurement (TOF: Time Of Flight). The time of flight of the transmitted and received light signals is in particular understood as the sum of the time of flight of the transmission light signals between the transmission and the incidence on the detected object and the time of flight of the reception light signals between the remission by the object and the incidence on the light receiver. The light receiver can have one or more light-sensitive reception elements and can in particular be designed as a line receiver or a 2D array.

Due to the relative offset between the light-sensitive surface and the reception optics, the reception light path, which can in particular be defined by the main axis of the reception light beam, extends obliquely to the optical axis of the reception optics according to the invention. The relative offset can be selected such that the angle between the reception light path and the optical axis or the plane defined above preferably amounts to less than one degree to a few degrees (in particular less than 5 to 10°), wherein the exact angle can depend on parameters such as the focal length of the reception optics and the size of the light-sensitive surface as well as the predefined working distance range. The magnitude of this angle can, for example, be determined by calculation or also experimentally. In principle, a greater reduction of the ghost images can be achieved with larger angles, wherein the imaging quality can, however, be disadvantageously influenced under certain circumstances.

The light-sensitive surface is arranged offset such that the reception light spot is indeed detected by the light-sensitive surface even at different working distances, but the ghost images of the reception light spot are not incident on the light receiver or at least its light-sensitive surface. For example, in biaxial arrangements, variations in the site of incidence of the reception light spot on the light-sensitive surface that typically occur due to varying object distances can be taken into account by a corresponding design of the distance sensor, in particular by a sufficiently large dimensioning of the light-sensitive surface, so that the reception light spots are indeed detected at least for all the object distances disposed within the predefined working distance range, but the ghost images are masked.

The restriction that the ghost images are not incident on the light-sensitive surface at least within a predefined working distance range is to be understood such that, under certain circumstances, the condition that ghost images of the reception light spot may not be incident on the light-sensitive surface does not have to be fulfilled, or at least not for every ghost image, for objects that are disposed outside the working distance range, i.e. for objects at very short or very long distances. As a rule, the working distance range of an optoelectronic sensor is defined in that a reliable object detection is ensured for objects that are located within the working distance range, even under adverse external conditions. In principle, the working distance range can also be selected smaller depending on the specific application. For objects at very short or very long distances, at which a reliable detection is anyway not possible for geometric reasons or due to the distance-related signal attenuation, an elimination of ghost images also does not necessarily have to be provided.

For a determination of the relative offset between the light-sensitive surface and the optical axis of the reception optics, as regards the (relative) position of the light-sensitive surface, the center of the light-sensitive surface can preferably be referenced as a reference point. In other words, the relative offset can in particular refer to a distance between the point of intersection of the optical axis of the reception optics with the plane of extent of the light-sensitive surface and the aforementioned center of the light-sensitive surface.

Since the reception light path is obliquely incident on the reception optics, it may be useful that the entire distance sensor or at least the reception arrangement is positioned pivoted by a corresponding angle so that the light paths have the same spatial position in the monitored zone as in a conventional distance sensor in which the light paths extend substantially perpendicular to the main planes of the optics.

According to a preferred embodiment, a detectable field of view is defined on a respective virtual auxiliary surface, which extends perpendicular to the optical axis of the reception optics, such that all the reception light signals produced within the detectable field of view are incident on the light-sensitive surface and all the reception light signals produced outside the detectable field of view are not incident on the light-sensitive surface, and the transmission arrangement is configured such that, at least within the predefined working distance range, the transmission light signals are incident on the virtual auxiliary surface substantially within the detectable field of view.

This virtual auxiliary surface is an imaginary surface which extends orthogonally to the optical axis of the reception optics and which can generally have any desired distance from the distance sensor at least within the predefined working distance range. The detectable field of view can in particular be understood as a partial surface of such an auxiliary surface that is bounded by a virtual back projection, which is produced by means of the reception optics, of the contour of the light-sensitive surface onto said virtual auxiliary surface. Only those transmission light signals which are remitted at an object surface located within this back projection of the contour are incident on the light-sensitive surface and can be detected. Due to the above definition, a solid angle region is in particular also defined in which objects must be located so that they can be “seen” by the light-sensitive surface. Thus, the field of view which can be detected at a respective object distance can also be understood as an intersection surface between the solid angle region and a virtual auxiliary surface located at this object distance. According to the laws of geometrical optics, the size of the detectable field of view depends on the respective object distance.

In principle, the entire detectable auxiliary surface is not illuminated with the transmission light signals, but rather only a specific partial region. The condition that the transmission light signals are incident on the imaginary auxiliary surface “substantially” within the detectable field of view is in particular to be understood such that a large proportion of the transmission light signals, preferably more than 50% of the intensity, further preferably more than 75%, are incident within the detectable field of view.

According to a further preferred embodiment, a detectable field of view is defined on a respective virtual auxiliary surface, which extends perpendicular to the optical axis of the reception optics, such that all the reception light signals produced within the detectable field of view are incident on the light-sensitive surface and all the reception light signals produced outside the detectable field of view are not incident on the light-sensitive surface, and the transmission arrangement is configured such that, at least within the predefined working distance range, no transmission light signals within a complementary region are incident on the virtual auxiliary surface, wherein the complementary region is defined by a point mirroring of the detectable field of view at the point of intersection of the optical axis of the reception optics with the virtual auxiliary surface.

Transmission light signals that would be remitted within this complementary region in the direction of the reception arrangement would indeed not be incident directly on the light-sensitive surface, but could very probably produce ghost images that would be incident on the light-sensitive surface in an unwanted manner. Due to the restriction of the illumination with transmission light to regions outside the complementary region, the unwanted detection of ghost images is prevented.

According to a further preferred embodiment, the amount of an offset between the light-sensitive surface and the optical axis of the reception optics can be changed, with the offset arrangement preferably being producible by a displacement of the light-sensitive surface and/or the reception optics. It is thereby possible to adapt the masking of ghost images to the respective specific situation of use of the distance sensor, for example, to optimize the masking for certain working distances. Preferably, the reception optics can be displaced laterally, i.e. transversely to its optical axis. In principle, alternatively or additionally, the lateral position of the light-sensitive surface can also be changed.

According to a further preferred embodiment, the offset arrangement of the light-sensitive surface with respect to the optical axis of the reception optics is produced by an offset arrangement of the light receiver. In other words, the entire light receiver can be mechanically displaced transversely to the optical axis of the reception optics.

According to a further preferred embodiment, the light receiver has a plurality of reception elements that can be selectively activated or deactivated, with the light-sensitive surface being formed by a totality of the activated reception elements, and with the offset arrangement of the light-sensitive surface with respect to the optical axis of the reception optics being produced by activating only a subset of the reception elements. For example, the light receiver can have a two-dimensional array with reception elements arranged in rows and columns, wherein the light-sensitive surface is defined by one or some few activated rows or columns. The changing of the amount of an offset between the light-sensitive surface and the optical axis of the reception optics can thus take place by activating different partial regions of the light receiver. The reception elements that do not belong to the light-sensitive surface are deactivated, wherein the deactivation can in particular also take place by not reading out or not considering the corresponding pixels of the light receiver during the evaluation. In this preferred embodiment, the offset of the light-sensitive surface relative to the optical axis can be varied electronically. The light receiver itself does not need to be mechanically displaced so that the structural design of the distance sensor is simplified. The subset or the partial range of the activated reception elements is preferably contiguous.

According to a further preferred embodiment, the transmission arrangement comprises a light source and a transmission optics that has an optical axis, wherein the light source and the transmission optics are arranged offset relative to one another transversely to the optical axis of the transmission optics such that one or more ghost images of the transmission light spot on the object, which are produced by unwanted reflections of the transmission light signals at boundary surfaces of the transmission optics, are not detected by the reception arrangement at least within a predefined working distance range. Thus, the fact is taken into account that ghost images of the transmission light spot can be produced in the transmission light path by unwanted reflections of the transmission optics, which can comprise one or more lenses, and can in particular also be projected onto a surface of an object present in the monitored zone and can be remitted by said surface. Such ghost images of the transmission light spot (which are to be distinguished from the aforementioned ghost images of the reception light spot) may under certain circumstances be detected by the reception arrangement as unwanted double images of the reception light spot that are not eliminated by the design of the reception arrangement according to the invention. The transmission light path and the optical axis of the transmission optics in particular extend obliquely to one another, wherein the light source and the transmission light spot do not lie on the optical axis of the transmission optics, but are preferably spaced apart from the optical axis of the transmission optics by a respective predefined amount.

According to a further preferred embodiment, the amount of an offset between the light source and the optical axis of the transmission optics can be changed, with the offset arrangement preferably being producible by a displacement of the light source and/or the transmission optics. In other words, the light source and/or the transmission optics can be mechanically adjusted with respect to their lateral position relative to the optical axis of the transmission optics. Alternatively, it is also conceivable that the light source is composed of a plurality of individual light sources at different distances from the optical axis of the transmission optics, wherein one of the individual light sources is activated in dependence on the desired amount of the offset.

According to a further preferred embodiment, the transmission light path and the optical axis of the transmission optics enclose a transmission angle and the reception light path and the optical axis of the reception optics enclose a reception angle, with the transmission angle and the reception angle being of equal magnitude. Thus, the transmission light path and the reception light path extend parallel to one another. In the preferred embodiment, an offset is thus produced between the light source and the transmission optics, said offset preferably being directed in the same direction as the offset between the light-sensitive surface and the reception optics and preferably also having the same amount, wherein the focus here is not on absolute magnitude values of the offset, but on the same exit angles or entry angles of the transmission light path or the reception light path. In principle, the “viewing direction” of the distance sensor can change when setting or changing the offset. Due to the offset directed in the same direction, the alignment of the distance sensor with respect to the monitored zone is simplified since the relative position of the transmission and reception light path is at least largely maintained. Any change in the viewing angle can be compensated for by an alignment of the distance sensor as a unit; a separate alignment of the transmission unit and reception unit is not necessary.

According to a further preferred embodiment, the distance sensor is configured as a scanning sensor, with at least the transmission light path, preferably also the reception light path, being rotated and/or periodically deflected about at least one axis of rotation to periodically scan the monitored zone in order to fulfill the actual sensor function. The rotation or periodic pivoting can take place during the monitoring by a rotation or a periodic pivoting of the transmission and/or reception arrangement and/or by means of a rotating or pivotable deflection element. The mentioned periodic pivoting in the context of the scanning of a monitored zone is a rotation in a limited angular range with a periodically changing direction of rotation.

In a further aspect in accordance with the features of the independent claim, the present invention relates to a method for adjusting or operating a distance sensor that is configured to detect objects in a monitored zone and that comprises: a transmission arrangement for transmitting transmission light signals along a transmission light path into the monitored zone; and a reception arrangement comprising at least one reception optics, which has an optical axis and which is configured to focus reception light signals, which are produced by an object present in the monitored zone by a remission of incident transmission light signals and which propagate along a reception light path between the object and the reception arrangement, into a reception light spot, and a light receiver that has a light-sensitive surface and that is configured to detect the reception light spot. With the distance sensor, a distance of the detected object from the distance sensor is determined in dependence on the time of flight of the transmitted and received light signals. The light-sensitive surface and the reception optics are arranged offset relative to one another transversely to the optical axis of the reception optics such that the optical axis of the reception optics does not intersect the light-sensitive surface so that one or more ghost images of the reception light spot, which are produced by unwanted reflections of the reception light signals at boundary surfaces of the reception optics, are not incident on the light-sensitive surface at least within a predefined working distance range.

In principle, a conventional distance sensor can thus also be modified such that the underlying principle of the distance sensor according to the invention can be implemented by carrying out the method.

Further advantages of the distance sensor according to the invention and the method according to the invention and advantageous embodiments and designs result from the following description of the drawings. In particular, advantageous embodiments of the distance sensor also represent advantageous embodiments of the method according to the invention and vice versa.

An embodiment example of the invention is shown in the drawings. The drawings, the description and the claims include numerous features in combination. The skilled person will expediently also consider these features individually and/or combine them into further sensible combinations.

### There Are Shown:

FIG. 1 schematic plan views of a light-sensitive surface of a light receiver and associated side views of the corresponding reception arrangements for different reception angles;

FIG. 2 a schematic view of a distance sensor according to the prior art;

FIG. 3 a plan view of the light-sensitive surface of the distance sensor of FIG. 2;

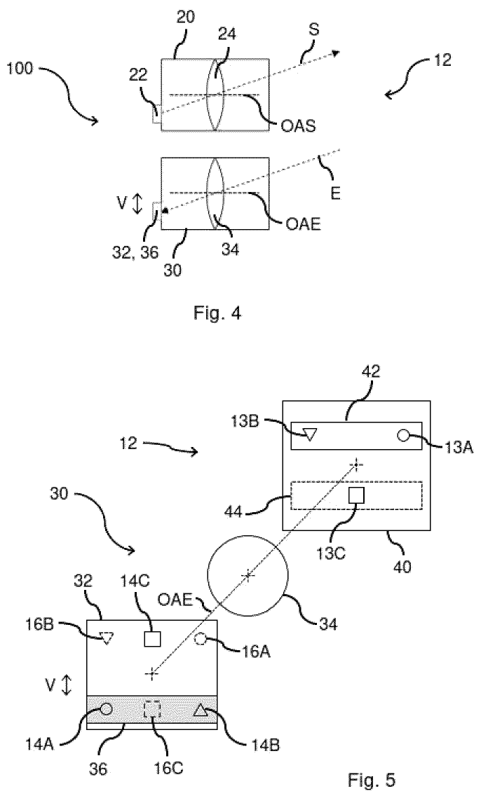

FIG. 4 a schematic view of a distance sensor according to an embodiment example; and

FIG. 5 a schematic perspective view of the reception arrangement of a modification of the distance sensor shown in FIG. 4.

For a better understanding of the underlying problem of the invention and the solution according to the invention, the influence of light reflections at boundary surfaces of a reception optics 34 of a reception arrangement 30 of a distance sensor 10 is first explained in general with reference to FIG. 1.

In FIG. 1, a respective reception light beam, which is remitted by an object (not shown) present in a monitored zone, is symbolized by the reception light path E, wherein the reception light path E is represented by the associated main beam shown as a dashed line. The angle of incidence on the reception optics 34 is also referred to below as the reception angle.

For an angle of incidence of 0°, a reception light spot 14 produced by the reception optics 34 and a ghost image 16 of the reception light spot 14 produced by reflections at boundary surfaces of the reception optics 34 coincide and are incident on the center of the light receiver 32 (or its light-sensitive surface that in FIG. 1 is identical to the surface of the light receiver 32).

As the angle of incidence increases (shown in FIG. 1 for an angle of incidence of 10° and 20°), the reception light spot 14 and the ghost image 16 move away from one another in the vertical direction, wherein the distance likewise increases as the angle of incidence increases. The diverging of the reception light spot 14 and the ghost image 16 in this respect takes place in a point symmetrical manner to a point of intersection of the optical axis of the reception optics 34 with the light receiver 32.

This point symmetry, which is not directly recognizable in FIG. 1, has the effect that for reception light paths E, which, as shown in the lower partial figures of FIG. 1, not only extend obliquely to the optical axis within the drawing planes, but additionally also in a direction orthogonal thereto, i.e. in the representation of FIG. 1 additionally have an angle of incidence different from 0° relative to the drawing plane, the reception light spot 14 and its ghost image 16 are additionally displaced laterally i.e. in a horizontal direction, with respect to one another.

The underlying problem of the invention will now be explained in more detail with respect to FIG. 2. FIG. 2 shows a distance sensor 10 in accordance with the prior art. The distance sensor 10 comprises a transmission arrangement 20 comprising a light source 22 and a transmission optics 24 as well as a reception arrangement 30 comprising a light receiver 32 and a reception optics 34. The transmission light emitted by the light source 22 is bundled by the transmission optics 24 and is transmitted along a transmission light path S in the direction of a monitored zone 12. If the transmission light signals are incident on an object (not shown)present in the monitored zone 12, the transmission light is remitted in the form of reception light signals in the direction of the distance sensor 10. The reception light signals propagate along a reception light path E, are focused by the reception optics 34 onto the light receiver 32 and are converted into electrical reception signals there. The transmission arrangement 20 and the reception arrangement 30 can be connected to an evaluation and control unit (not shown) that evaluates the electrical reception signals and in particular also controls the light source 22 to determine the distance between the distance sensor 10 and the detected object on the basis of the time-of-flight method.

Both the transmission light path S and the reception light path E coincide with the optical axes of the transmission optics 24 and the reception optics 34 in each case. In the example of FIG. 2, the transmission arrangement 20 and the reception arrangement 30 are arranged laterally to one another, i.e. offset from one another in a transverse direction to the optical axes of the transmission optics 24 and the reception optics 34. This arrangement is also designated as a biaxial arrangement. In the schematic (and not to scale) representation of FIG. 2, the transmission light path S and the reception light path E extend parallel to one another. In reality, this parallelism only exists for an infinitely distant object. In real arrangements, the object is located closer to the distance sensor 10. The parallax error resulting therefrom can be compensated for by a corresponding adjustment or alignment of the transmission arrangement 20 and/or the reception arrangement 30.

Due to the transmission arrangement, a more or less focused transmission light spot on an object possibly present in the monitored zone 12 is produced. If the transmission light spot is at least approximately point-shaped and lies on the optical axis of the reception optics 34, the reception light spot 14 and its possibly present ghost image 16 coincide (cf. the left-hand partial figure of FIG. 1 for an angle of incidence of 0°). However, if the transmission light spot is not point-shaped, e.g. is linear or is composed of a plurality of partial light spots, or does not lie on the optical axis of the reception optics 34, e.g. due to a parallax error, the reception light spot 14 and its possibly present ghost image 16 can be incident on the light receiver 32 at different locations. In particular with a longitudinally extended transmission light spot, such as can be produced by a linear light source, by a series arrangement of a plurality of partial light sources or by a scanning deflection of a transmission light beam, errors can occur during a spatially resolved detection of the reception light spot 14. For example, a ghost light spot 16 could be incorrectly interpreted as a further reception light spot that was remitted by a supposed additional object spaced apart from the real object.

This will be explained in more detail with respect to FIG. 3. On a light-sensitive surface of the light receiver 32, a partial region designated as the reception zone 46 is shown as a gray-filled rectangle. This reception zone 46 here corresponds to a (virtual) corresponding large transmission light spot, which is remitted over its entire extent, and can therefore also be regarded as a “field of view” for possibly present objects. Only objects that are located within this “field of view” can be detected. A object (e.g. a circular object) that is located within this “field of view” but outside the optical axis of the reception optics OAE and that is illuminated by such a transmission light spot thus produces the (circular) reception light spot 14 and an associated ghost image 16 of the reception light spot 14. The ghost image 16 can lead to incorrect detections of objects under certain circumstances.

A distance sensor 100 according to an embodiment example will be described in the following with reference to FIG. 4. Only the main differences compared to the representation of FIG. 2 will now be explained in the following.

In the distance sensor 100, compared to the distance sensor 10 of FIG. 2, both the light source 22 and the light receiver 32 are arranged offset by a certain amount in an offset direction V relative to the optical axis of the transmission optics OAS or to the optical axis of the reception optics OAE.

Due to the displacement of the light source 22 or the light receiver 32 in the offset direction V, the transmission light path S and the reception light path E extend obliquely to the optical axes OAS and OAE, respectively, compared to the representation of FIG. 2, wherein the respective angles are only shown purely schematically here and can also be larger or smaller than the angles in the representation of FIG. 4, depending on the geometry. While the reception light spot 14 is incident on the light receiver 12, its ghost image 16 is shifted upwards in the direction of the offset direction V and no longer reaches the light receiver 32. In a corresponding manner, the transmission light spot projected onto an object present in the monitored zone and the ghost image of said transmission light spot are also pulled apart in the transmission light path. The orientation of the transmission arrangement 20 and the reception arrangement 30 in this respect takes place such that only the transmission light spot falls into the field of view of the reception arrangement 30, but its ghost image lies outside the field of view and is therefore not detected.

According to a modification that is likewise in accordance with the invention, instead of a mechanical displacement-as already described above-of the entire light receiver 32, only the light-sensitive surface 36 can also be arranged offset from the optical axis of the reception optics OAE in the offset direction V. In the modification, the offset arrangement of the light-sensitive surface 36 is based on the fact that only the receiver elements of the light receiver 32 that are present within a selected light-sensitive surface 36, said light receiver possibly having a larger surface area, are activated, read out or considered in the evaluation.

A perspective view of the reception arrangement 30 that corresponds to this modification is shown in FIG. 5. The mode of operation of the underlying principle of the invention will additionally be explained with reference to FIG. 5.

Due to the displacement of the light-sensitive surface 36 in the offset direction V, it lies outside the point of intersection of the light receiver 32 with the optical axis of the reception optics OAE.

A virtual auxiliary surface 40 is shown in the monitored zone 12 and extends orthogonally to the optical axis of the reception optics OAE. The virtual auxiliary surface 40 is intended to serve as a definition basis for the geometric conditions described below that are based on the principles of geometrical optics. The distance of said virtual auxiliary surface from the reception arrangement 30 can generally be freely selected within the predefined working distance range.

Within the auxiliary surface 40, a detectable field of view 42 is shown that can be understood as a partial surface of the auxiliary surface 40 that is bounded by a virtual back projection, which is produced by means of the reception optics 34, of the contour of the light-sensitive surface 36 onto the virtual auxiliary surface 40. The field of view 42 is characterized in that only those transmission light signals which are remitted at an object surface located within the field of view 42, i.e. the back projection of the light-sensitive surface 36, are incident on the light-sensitive surface 36 and can be detected. According to the laws of geometrical optics, the size of the detectable field of view 42 depends on the respective object distance.

The transmission arrangement (not shown in FIG. 5) is sensibly configured such that the transmission light spot produced by said transmission arrangement illuminates the entire field of view 42 completely or at least for the most part.

For an easier understanding, objects 13A-13C with different contours are shown in FIG. 5 that are located within the auxiliary plane 40. If these objects 13A-13C are illuminated with a transmission light spot, the reception optics 34 produces corresponding reception light spots 14A-14C from the remitted transmission light as images of the objects 13A-13C on the light receiver 32. Due to unwanted reflections at or in the reception optics 34, ghost images 16A-16C can be produced whose position and location on the light receiver 32 correspond to point-symmetrical images of the reception light spots 14A-14C in the plane of extent of the light receiver 32, wherein the point of symmetry of these images is given by the point of intersection of the optical axis of the reception optics OAE with the light receiver 32 or its plane of extent.

The reception light spot 14A and the ghost image 16A are assigned to the circular object 13A, the reception light spot 14B and the ghost image 16B are assigned to the triangular object 13B, and the reception light spot 14C and the ghost image 16C are assigned to the square object 13C.

The objects 13A, 13B disposed within the field of view 42 are imaged onto the light-sensitive surface 36. Due to the relative offset according to the invention between the light-sensitive surface 36 and the reception optics 34, the associated ghost images 16A, 16B, however, fall onto regions of the light receiver 32 that lie outside the light-sensitive surface 36 and that are therefore also not detected or at least considered in the evaluation.

So that a detection of ghost images can be reliably avoided, a sensible limitation of the transmission light spot must be ensured. This is explained in more detail with reference to the object 13C. The object 13C is located outside the field of view 42 so that the associated reception light spot 14C is not incident on the light-sensitive surface 36. Due to the point symmetry, the associated ghost image 16C, however, lies within the light-sensitive surface 36 and leads to unwanted incorrect detections there.

The transmission light spot should therefore be limited so that certain regions on the auxiliary surface 40 are not illuminated. Advantageously, the transmission spot is limited so that it substantially only illuminates the field of view 42. In particular, however, it should be avoided that transmission light falls into a complementary region 44 that is defined by a point mirroring of the detectable field of view 42 at the point of intersection of the optical axis of the reception optics OAE with the auxiliary surface 40. It can be seen from FIG. 5 that, if the complementary region 44 is not illuminated, no ghost image 16C of the object 13C can be produced on the light-sensitive surface 36 either.

The field of view 42 and the complementary region 44 are each shown as rectangular regions. However, the reception optics 34 can possibly also distort (pincushion distortion or barrel distortion) the field of view 42 and the complementary region 44 in the (imaginary) back projection of the light-sensitive surface 36 due to the tilted reception light path E. Therefore, the field of view 42 and the complementary region 44 do not necessarily have to be rectangular, but can, for example, have a contour distorted in a banana shape. A corresponding distortion can also occur when producing the transmission light spot. Due to a complementary design of the transmission arrangement (e.g. the same offset, transmission optics and reception optics the same), this can be used for an advantageous matching of the shape of the transmission light spot to the shape of the field of view 42.

According to a modification of, for example, the distance sensor 100 of FIG. 4 (or in a corresponding manner in an arrangement in which the light-sensitive surface 36 is defined by activated light elements of the light receiver 32), the design of the reception arrangement 30 shown there can be combined with the (conventional) design of the transmission arrangement 20 of the distance sensor 10 (FIG. 2), i.e. said offset is only provided in the reception arrangement 30, but not in the transmission arrangement 20.

For a better understanding, in the embodiment examples shown, the relative offset between the light source 22 and the transmission optics 24 or the relative offset between the light receiver 32 or the light-sensitive surface 36 and the reception optics 34 was produced by a displacement of the light source 22 and the light receiver 32 or the light-sensitive surface 36. Alternatively or additionally, according to further modifications, the relative offset can also be produced by a displacement of the transmission or reception optics 24, 34.

In both the embodiment example and its modifications, the changes in direction of the light paths E, S caused by the relative offsets can be compensated for by a corresponding pivoting of the transmission arrangement 20 or the reception arrangement 30.

### REFERENCE NUMERAL LIST

10, 100 distance sensor
12 monitored zone
13A-13C object
14, 14A-14C reception light spot
16, 16A-16C ghost image
20 transmission arrangement
22 light source
24 transmission optics
30 reception arrangement
32 light receiver
34 reception optics
36 light-sensitive surface
40 auxiliary surface
42 field of view
44 complementary region
46 reception zone
E reception light path
S transmission light path
OAE optical axis of the reception light path
OAS optical axis of the transmission light path
V offset direction

1. A distance sensor for detecting objects in a monitored zone, said distance sensor comprising
a transmission arrangement for transmitting transmission light signals along a transmission light path into the monitored zone;
a reception arrangement comprising a reception optics, which has an optical axis and which is configured to focus reception light signals, which are produced by an object present in the monitored zone by a remission of incident transmission light signals and which propagate along a reception light path between the object and the reception arrangement, into a reception light spot, and a light receiver that has a light-sensitive surface and that is configured to detect the reception light spot; and
an evaluation unit that is connected to the light receiver and that is configured to determine a distance of the detected object from the distance sensor in dependence on the time of flight of the transmitted and received light signals,
wherein the light-sensitive surface and the reception optics are arranged offset relative to one another transversely to the optical axis of the reception optics such that the optical axis of the reception optics does not intersect the light-sensitive surface so that one or more ghost images of the reception light spot, which are produced by unwanted reflections of the reception light signals at boundary surfaces of the reception optics, are not incident on the light-sensitive surface at least within a predefined working distance range.

2. The distance sensor according to claim 1,
wherein a detectable field of view is defined on a respective virtual auxiliary surface, which extends perpendicular to the optical axis of the reception optics, such that all the reception light signals produced within the detectable field of view are incident on the light-sensitive surface and all the reception light signals produced outside the detectable field of view are not incident on the light-sensitive surface, and
wherein the transmission arrangement is configured such that, at least within the predefined working distance range, the transmission light signals are incident on the virtual auxiliary surface substantially within the detectable field of view.

3. The distance sensor according to claim 1,
wherein a detectable field of view is defined on a respective virtual auxiliary surface, which extends perpendicular to the optical axis of the reception optics, such that all the reception light signals produced within the detectable field of view are incident on the light-sensitive surface and all the reception light signals produced outside the detectable field of view are not incident on the light-sensitive surface, and
wherein the transmission arrangement is configured such that, at least within the predefined working distance range, no transmission light signals within a complementary region are incident on the virtual auxiliary surface, wherein the complementary region is defined by a point mirroring of the detectable field of view at the point of intersection of the optical axis of the reception optics with the virtual auxiliary surface.

4. The distance sensor according to claim 1,
wherein the amount of an offset between the light-sensitive surface and the optical axis of the reception optics can be changed.

5. The distance sensor according to claim 4,
wherein the offset arrangement is producible by a displacement of the light-sensitive surface and/or the reception optics.

6. The distance sensor according to claim 1,
wherein the offset arrangement of the light-sensitive surface with respect to the optical axis of the reception optics is produced by an offset arrangement of the light receiver.

7. The sensor according to claim 1,
wherein the light receiver has a plurality of reception elements that can be selectively activated or deactivated, with the light-sensitive surface being formed by a totality of the activated reception elements, and with the offset arrangement of the light-sensitive surface with respect to the optical axis of the reception optics being produced by activating only a subset of the reception elements.

8. The distance sensor according to claim 1,
wherein the transmission arrangement comprises a light source and a transmission optics that has an optical axis, and wherein the light source and the transmission optics are arranged offset relative to one another transversely to the optical axis of the transmission optics such that one or more ghost images of the transmission light spot on the object, which are produced by unwanted reflections of the transmission light signals at boundary surfaces of the transmission optics, are not detected by the reception arrangement at least within a predefined working distance range.

9. The sensor according to claim 8,
wherein the amount of an offset between the light source and the optical axis of the transmission optics can be changed.

10. The distance sensor according to claim 9,
wherein the offset arrangement is producible by a displacement of the light source and/or the transmission optics.

11. The distance sensor according to claim 1,
wherein the transmission light path and the optical axis of the transmission optics enclose a transmission angle and the reception light path and the optical axis of the reception optics enclose a reception angle, with the transmission angle and the reception angle being of equal magnitude.

12. The distance sensor according to claim 1,
wherein the distance sensor is configured as a scanning sensor, with at least the transmission light path being rotatable and/or pivotable about at least one axis of rotation.

13. The distance sensor according to claim 12,
wherein also the reception light path is rotatable and/or pivotable about at least one axis of rotation.

14. A method for adjusting and/or operating a distance sensor that is configured to detect objects in a monitored zone and that comprises:
a transmission arrangement for transmitting transmission light signals along a transmission light path into the monitored zone; and
a reception arrangement comprising a reception optics, which has an optical axis and which is configured to focus reception light signals, which are produced by an object present in the monitored zone by a remission of incident transmission light signals and which propagate along a reception light path between the object and the reception arrangement, into a reception light spot, and a light receiver that has a light-sensitive surface and that is configured to detect the reception light spot,
wherein the distance sensor determines a distance of the detected object from the distance sensor in dependence on the time of flight of the transmitted and received light signals,
wherein the light-sensitive surface and the reception optics are arranged offset relative to one another transversely to the optical axis of the reception optics such that the optical axis of the reception optics does not intersect the light-sensitive surface so that one or more ghost images of the reception light spot, which are produced by unwanted reflections of the reception light signals at boundary surfaces of the reception optics, are not incident on the light-sensitive surface at least within a predefined working distance range.

15. The method according to claim 14,
wherein the light receiver has a plurality of reception elements that can be selectively activated or deactivated and the offset arrangement of the light-sensitive surface with respect to the optical axis of the reception optics is produced by activating only a subset of the reception elements.

16. The method according to claim 14,
wherein a detectable field of view is defined on a respective virtual auxiliary surface, which extends perpendicular to the optical axis of the reception optics, such that all the reception light signals produced within the detectable field of view are incident on the light-sensitive surface and all the reception light signals produced outside the detectable field of view are not incident on the light-sensitive surface,
wherein, at least within the predefined working distance range, the transmission light signals are incident on the virtual auxiliary surface substantially within the detectable field of view, and
wherein the transmission arrangement comprises a light source and a transmission optics that has an optical axis, with the light source and the transmission optics being arranged offset relative to one another transversely to the optical axis of the transmission optics, wherein one or more ghost images of the transmission light spot on the object, which are produced by unwanted reflections of the transmission light signals at boundary surfaces of the transmission optics, are not detected by the reception arrangement at least within a predefined working distance range.
